(19) United States
(12) Patent Application Publication
(10) Pub. No.: US 2023/0248482 A1
(43) Pub. Date: Aug. 10, 2023

(54) DENTAL AND ORTHOPEDIC FASTENER WITH DIRECTIONAL SHOCK ABSORBER

(71) Applicant: Move Dental LTD, Tel Aviv (IL)

(72) Inventor: Oz Vachtenberg, Tel Aviv (IL)

(73) Assignee: Move Dental LTD, Tel Aviv (IL)

(21) Appl. No.: 18/133,810

(22) Filed: Apr. 12, 2023

Related U.S. Application Data
(63) Continuation-in-part of application No. PCT/IB21/00694, filed on Oct. 13, 2021.
(60) Provisional application No. 63/330,598, filed on Apr. 13, 2022.
(60) Provisional application No. 63/091,663, filed on Oct. 14, 2020.

(51) Int. Cl. A61C 8/00

(52) U.S. Cl. CPC A61C 8/0086; A61C 8/0068; A61C 8/0022; A61C 13/0019

(57) ABSTRACT

An implant body having a coronal end and an opposing apical end, an outer surface and a compartment extending therein from a coronal end toward the apical end, the implant body including a gap between the compartment or spherical head portion and the outer surface.

### CROSS-REFERENCE TO RELATED PATENT APPLICATIONS

This application is a continuation-in-part application of PCT Application No. PCT/IB21/00694 entitled DENTAL AND ORTHOPEDIC FASTENER WITH DIRECTIONAL SHOCK ABSORBER, filed Oct. 13, 2021, which claims the benefit of U.S. Patent Application 63/091,663, filed Oct. 14, 2020, entitled Dental Implant with Shock Absorber, and this application claims the benefit of U.S. Application No. 63/330,598, filed Apr. 13, 2022, entitled DENTAL AND ORTHOPEDIC FASTENER WITH DIRECTIONAL SHOCK ABSORBER all of which are incorporated herein by reference in their entirety.

### BACKGROUND

The present invention pertains to a dental implant and orthopedic fastener with shock absorbing properties.

A living tooth has a root which rests in the periodontal membrane, located between the root of the tooth and the jawbone. This membrane consists of tiny fibers that together provide a cushion which spreads and distributes the impact force transmitted from the tooth to the jawbone during mastication. In this manner the periodontal membrane acts as a shock absorber and has a damping effect on the impact force which the tooth receives thus providing a degree of flexibility between the crown and the alveolar process of the jaw.

Conventional dental implants rely on direct adhesion of bone tissue to the implant Without the intervening periodontal membrane and its cushioning effect the impact stress concentrations which the jawbone encounters from an implant may result over time in bone resorption and loosening of the implant or trauma to the overlying soft tissue.

Implants are used in areas other than the jaw. Implants such as pedicle screws have been used to treat spinal disorders. The implants may also be secured to bones of the spine to secure rods extending between the bones.

### SUMMARY

In one embodiment a dental implant includes an implant body having a coronal end and an opposing apical end, an outer surface and a compartment extending therein from a coronal end toward the apical end, the implant body including a gap between the compartment and the outer surface.

A dental implant includes an implant body having a coronal end and an apical end opposite the coronal end, an outer surface, and a compartment extending therein from a coronal end toward the apical end. The implant body includes a gap between the compartment and the outer surface, wherein the gap is a closed hermitically sealed space.

In a further aspect of the dental implant the compartment is defined by an internal surface being movable with respect to the outer surface of the implant body by deformation and flexibility of the implant body in a region closer to the coronal end than the apical end.

In one embodiment a dental implant includes an implant body having a coronal end and an opposing apical end, an outer surface and a cavity extending into the implant body from a coronal end toward the apical end. The implant body including a sealed space between the cavity and the outer surface. An internal surface of the cavity is movable with respect to the outer surface of the implant body by deformation of the sealed space.

In one embodiment an implant body includes a coronal end and an opposing apical end, the implant body including a first portion connected to a second portion defining a gap therebetween. The first portion has an outer surface, and the second portion includes a compartment extending therein from the coronal end toward the apical end. The second portion being movable relative to the first portion by deformation of the body material changing the geometry of the gap.

In one embodiment a dental implant includes an implant body having a coronal end and an opposing apical end, the implant body including a first portion connected to a second portion defining gap therebetween, the gap defining a closed hermetically sealed space. The second portion having an outer surface, and the first portion including a compartment extending therein from the coronal end toward the apical end. The first portion being movable relative to the second portion by deformation and flexibility of a region of the implant body changing a geometry of the gap. The dental implant further includes an abutment received within the compartment, and a prosthetic crown.

An orthopedic fastener including a fastener body having a head, a neck, a threaded body and a distal tip. The fastener body including a hermetically sealed circumferentially extending gap between an outer surface of the fastener body and a longitudinal axis of the fastener body; the neck including a deformation region proximate the head that deforms upon an application of a force to the head allowing the head to bend relative to the longitudinal axis of the threaded body.

An implant includes a fastener body having an externally threaded region with a distal tip and a proximal portion having a proximal end furthest from the distal tip along a longitudinal axis of the fastener body. The fastener body including a hermetically sealed circumferentially extending gap between an outer surface of the fastener body and the longitudinal axis of the fastener body; the fastener body includes a deformation region closer to the proximal end than the distal tip that deforms upon an application of a force to the proximal portion allowing the proximal portion to bend relative to the longitudinal axis of the threaded body.

In one implementation the externally threaded region is configured to be inserted into a bone of a patient in an in-use position and a part of the proximal portion of the portion end remains exposed from the bone in an in-use position.

In one implementation the proximal portion includes an exposed compartment that receives a prosthetic abutment supporting a crown for use as a dental implant, wherein the bone is the jaw.

In one implementation the proximal portion includes a tool receiving compartment to permit rotation of the fastener body to secure the threaded region into the bone of a patient, wherein the bone is a spinal bone.

In one implementation the proximal portion of the fastener that has no bone fixation properties and extends outside the bone in-use position, the extended portion includes a spherical or any other shape to be connected to an orthopedic system.

An implant includes a fastener body having an externally threaded region with a distal tip and a proximal portion having a proximal end furthest from the distal tip along a longitudinal axis of the fastener body. The fastener body including a hermetically sealed circumferentially extending gap between an outer surface of the fastener body and the longitudinal axis of the fastener body; The fastener body has a cantilever structure. The proximal portion has a flexible and deformable properties while the other end toward the distal end is fixed and supported.

In one implementation an implant includes a fastener body having an externally threaded region with a distal tip and a proximal portion having a proximal end furthest from the distal tip along a longitudinal axis of the fastener body. The fastener body including a hermetically sealed circumferentially extending gap between an outer surface of the fastener body and the longitudinal axis of the fastener body. The fastener body includes a deformation region closer to the proximal portion than the distal tip that deforms upon an application of a force to the proximal portion allowing the proximal portion to bend relative to the longitudinal axis of the threaded region only along a single axis perpendicular to the longitudinal axis of the fastener body.

### BRIEF DESCRIPTION OF THE DRAWINGS

FIG. 1 is a partial cross-sectional view of a dental implant.

FIG. 2 is an exploded view of the dental implant of FIG. 1.

FIG. 3 is the dental implant of FIG. 1 showing the relative diameters and distances of various features of the dental implant.

FIG. 4A is a side plan view of the implant of FIG. 1.

FIG. 4B is a cross sectional view of FIG. 4A taken generally along the line of 4B-4B.

FIG. 5 is a cross sectional view of the dental implant with the bore in a neutral position.

FIG. 6 is a cross sectional view of the dental implant of FIG. 2 with the bore portion of the implant in a flexed position.

FIG. 7 is a partial cross-sectional view of the dental implant of FIG. 1 with a prosthesis.

FIG. 8 is a partial cross-sectional view of a dental implant.

FIG. 9 is a partial cross-sectional view of a dental implant.

FIG. 10 is an exploded view of the dental implant of FIG. 9.

FIG. 11 is a closeup view of a portion of the dental implant taken generally along line 11-11 of FIG. 9.

FIG. 12 is an isometric partial cross-sectional view of implant 220.

FIG. 13 is a closeup view of a portion of the dental implant taken generally along line 13-13 of FIG. 12.

FIG. 14 is an exploded view of the dental implant assembly.

FIG. 15 is cross-sectional view an orthopedic fastener.

FIG. 16 is a closeup view of a portion of the orthopedic fastener taken generally along line 16-16 of FIG. 15.

FIG. 17 is a plan view of an orthopedic fastening system.

FIG. 18 is a close-up partial view of an orthopedic fastener in stressed position.

FIG. 19 is a cross-sectional view of an orthopedic fastener with an extension portion.

FIG. 20 is an isometric view of an orthopedic fastener.

FIG. 21 is a partial cross-sectional view of the orthopedic fastener of FIG. 20.

FIG. 22 is a cross-sectional view of the orthopedic fastener taken generally along line 22-22 of FIG. 21.

FIG. 23A is a top view of an orthopedic fastener.

FIG. 23B is a cross-sectional view of the orthopedic fastener of FIG. 23A taken along line A-A.

FIG. 23C is a cross-sectional view of the orthopedic fastener of FIG. 23A taken along line B-B.

FIG. 23D is a cross-sectional view taken along line D-D of FIG. 23B.

FIG. 23E is a cross-sectional view taken along line E-E of FIG. 23C.

FIG. 23F is a partial a close-up view FIG. 23B about line G-G.

### DETAILED DESCRIPTION OF THE EXAMPLE EMBODIMENTS

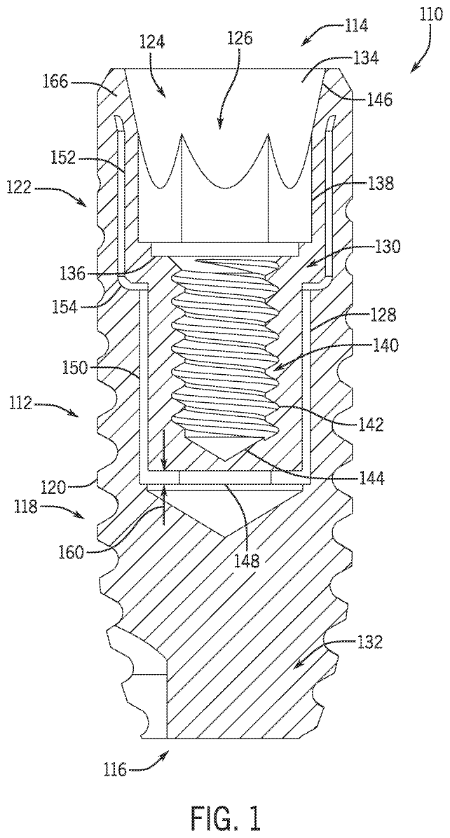

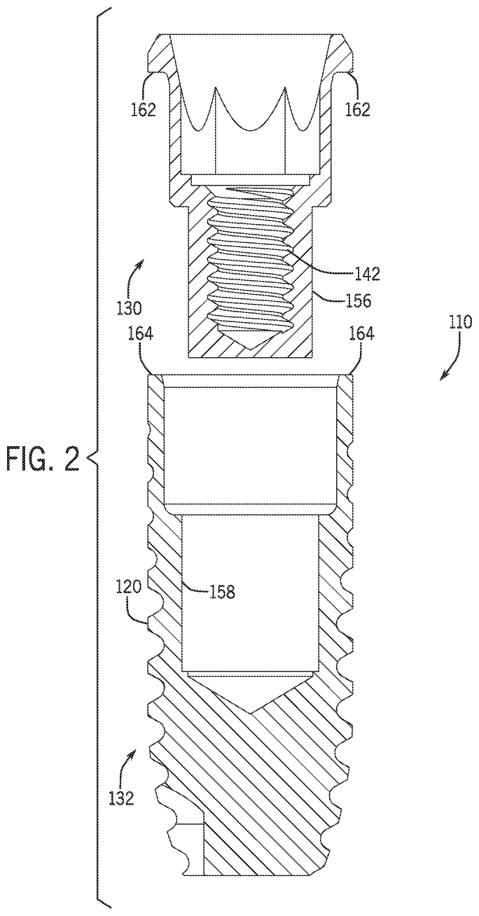

Referring to FIG. 1 and FIG. 2 a dental implant 110 includes an implant body 112 having a coronal end 114 and an opposing apical end 116. Implant body 112 has an outer surface 118 that in one embodiment includes outer threads 120. Implant body 112 includes a head region 122 having an opening 124 into a compartment 126 that extends from the coronal end 114 into the implant body 112 toward the apical end 116. Implant body 112 includes a gap 128 defined as the space between a first portion 130 of implant body 112 and a second portion 132 of implant body. The term apical end as used herein refers to a first end of implant body 112 located within a bone when implant body 112 is secured to a bone such as a jaw. The term coronal end as used herein refers to a second end the location of implant body 112 that is furthest from the apical end when the implant body 112 is secured to the bone. In one implementation the coronal end of implant 112 is the portion of implant 112 that is external to a patient's bone when implant 112 is secured to the patient's bone and apical end is the portion of implant 112 is positioned within the patient's bone when implant 112 is secured to the patient's bone.

Compartment 126 is located within first portion 130 and includes a first region 134 adjacent the coronal end 114 that is non-threaded and includes an abutment ledge 136 and internal side wall 138 that in one embodiment forms a hexagonal recess. Compartment 126 includes a second region 140 having internal threads 142 and a terminal bottom 144.

In one embodiment compartment first region 134 includes a generally beveled surface 146 narrowing in diameter from the coronal end 114 toward wall 138 and abutment ledge 136.

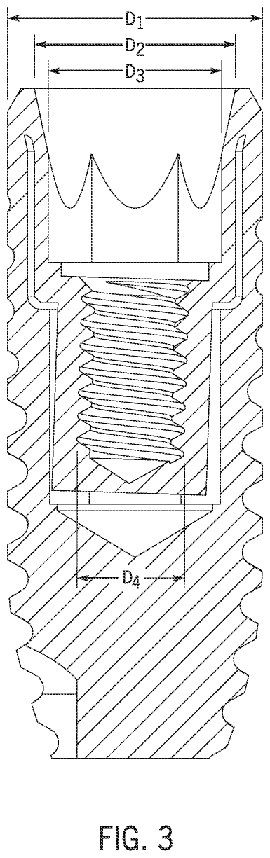

Referring to FIG. 3, outer or second portion 132 has an outer diameter D1. Compartment opening 124 has a diameter D2. Abutment ledge 136 has a diameter D3. Internal threads 142 has a diameter D4. Diameter D4 is less than the diameter of abutment ledge D3. The diameter D2 of opening 124 is less than the outer diameter D1 of first portion 130. Compartment 126 provides a support and attachment to the prosthetic feature. In one embodiment compartment includes a bevel shape 146, a polygon 138 and internal thread. In one embodiment some of these features but not all are included in compartment 126.

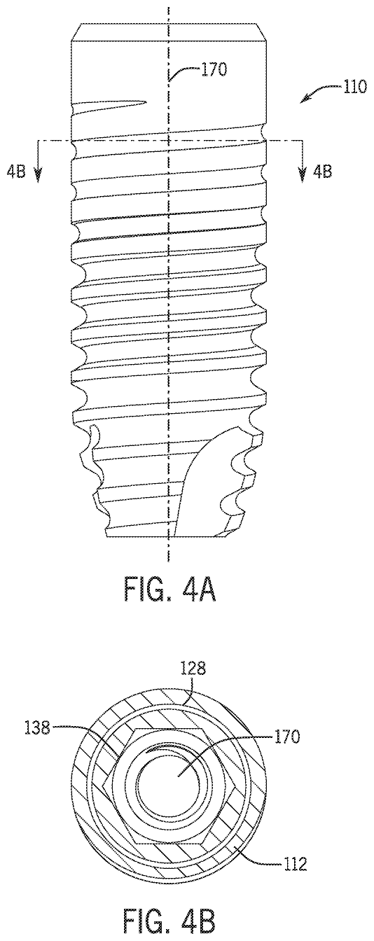

Referring to FIG. 4A and FIG. 4B, gap 128 extends 360 degrees about a longitudinal axis 170 of body 112 of implant 110. Gap 128 includes a bottom portion 148 that forms a disc. Gap 128 includes a first cylindrical side wall space 150 in fluid communication with bottom portion 148. Gap 128 includes a second cylindrical side wall space 152 connected to first side wall space 150 with a transition space 154. Second cylindrical side wall space 152 terminates in the head region 122.

In one embodiment gap 128 is a gap defined by the region between first or inner portion 130 and a second or outer portion 132. Inner portion 130 includes the material between internal threads 134 and an outer surface 156. Second or outer portion 132 includes the material between outer threads 120 and an inner surface 158. Gap 128 is the space defined between the outer surface 156 of inner portion 130 and the inner surface 158 of outer portion 132. In one embodiment the distance 160 defining the space between the outer surface 156 and inner surface 158 is between 0.02 and 3.0 mm with a preferred distance of 0.15 mm. In one embodiment distance 160 is substantially consistent along the entire gap 128. In one embodiment distance 160 varies such that the distance in one region of the sealed space is different that the distance in a different region of the sealed space. For example, the distance of gap 128 may be the same for all gap regions including first cylindrical side wall space 150, second cylindrical side wall space 152, a transition space 154 and the bottom portion 148.

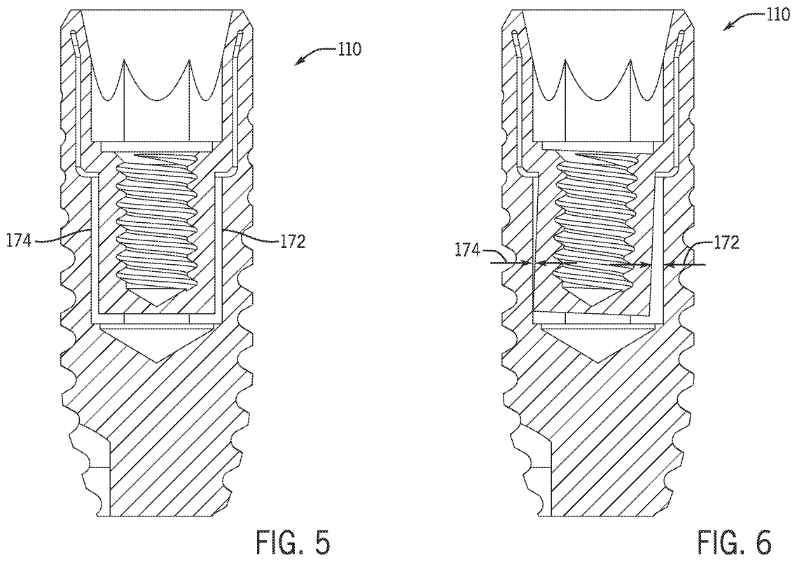

A connection 166 between a region 162 of first portion 130 and a region 164 of second portion 132. Connection 166 extends 360 degrees about implant body 112. Referring to FIG. 4A, FIG. 4B and FIG. 5 inner portion 130 moves relative to outer portion 132 upon the application of a force to the inner portion 130 through an abutment 168. Abutment 168 includes an apical portion inserted into compartment xxx and a portion of abutment 168 proximate the coronal end 114 of implant body 112 is welded to the coronal end implant body 112. A crown (not shown) is secured to the coronal end of abutment 168. In one implementation the abutment includes a threaded member that is threadedly received in generally internal threads 142 thereby securing the crown to implant 110. In one embodiment a threaded connector (not shown) is inserted through abutment 168 and threadedly connected to internal threads 142 thereby securing abutment 168 to implant body 112.

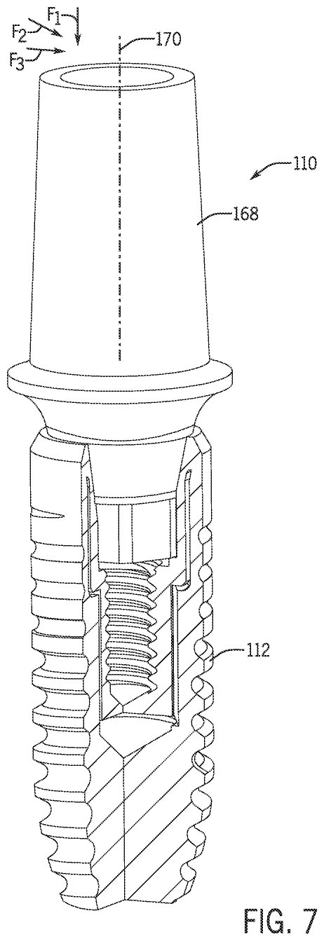

Referring to FIG. 5-7 when a force F is applied to the implant body from the abutment 168, first portion is able to move relative to the second portion by deformation of the material and flexibility of the implant body structure, such that the distance of the gap 128 is modified. Referring to FIG. 5 in one embodiment gap 128 is uniform 360 degrees about the longitudinal axis of insert 110 in an unloaded state. The distance of gap 128 at a first location 172 is equal to the distance of gap 128 at a second location 174 that is 180 degrees from first location 172. Referring to FIG. 6 when implant 110 is in a load stated gap 128 in a deformed position and is not uniform 360 degrees about the longitudinal axis of the insert. When a force is applied to the insert body having a direction lateral to the longitudinal axis the size of the gap at a first location 172 will be different than the size of the gap at a second location 174 positioned 180 degrees from the first location 172. In one embodiment the gap at the second location 174 will be zero mm. In one embodiment the gap at the first location 172 will be greater than zero mm and greater than the gap at the second location 174 when a force is being applied to abutment 168 but less when there is no force being applied to abutment 168. Stated another way the gap at second location 174 is less when a force is applied to the prosthetic attachment in a load state then when implant body is in a neutral non-load state. The difference between the size of gap at first location 172 and the size of gap at second location 174 depends on the amount of the external lateral force. When the external force applied to the insert is greater than a predetermined amount the size of gap at second location 174 becomes zero and the external force is then carried by the second portion 132.

The force applied to the first portion 130 may be applied in a vector F1 direction parallel to the longitudinal axis of the implant body or may be applied in a vector direction F2 non-parallel to the longitudinal axis at a non-perpendicular angle to longitudinal axis 170. Force F may also be in a direction F3 perpendicular to longitudinal axis 170. Referring to FIG. 5 in a neutral non-biased state gap 128 has a certain distance as defined above. In one embodiment the gap 128 distance is uniform 360 degrees about the longitudinal axis of the insert. Referring to FIG. 6 when a force is applied to the insert, the first portion moves relative to the second portion in a biased state such that the distance of gap 128 is not uniform about the longitudinal axis of the insert. In one embodiment in the biased state the distance of gap 128 at a first location 172 is greater than the distance of gap 128 at a second location 174 positioned 180 degrees from location 172. Where positions 172 and 174 are in a plane that is perpendicular to the longitudinal axis of the insert. In one embodiment the plane does not intersect the coronal and apical ends of the insert. In one embodiment first portion or inner member 130 can move relative to the second portion or outer member 132 a greater distance in a direction non-parallel to the longitudinal axis than in a direction parallel to the longitudinal axis 170.

In one embodiment gap 128 is hermitically sealed between first portion 130 and second portion 132 by connection 166. Gap 128 in one embodiment includes only a gas. In one embodiment gap 128 includes a material different from the material of the first portion 130 and the material of the second portion 132. The second material can be selected to provide a desired stiffness to provide the desired shock absorbing characteristic to a force applied to the first portion 130 through an abutment 168. In use when implant body is attached to a patient's jaw and the jaw heals second portion 132 is fixed to and does not move relative the patient's jaw. As described herein, forces applied to the prosthetic attachment by the person through masticating is translated to the first portion 130 which is able to move relative to the second portion 132 which is fixed to the jaw by deformation of gap 128.

Gap 128 in one embodiment is hermitically sealed thereby avoiding bacteria from entering Gap 128 from a region external to the implant body such as a person's mouth.

In one embodiment first portion 130 and second portion 132 of dental implant body 112 is made of titanium and welded together along connection 166 in such a manner to create gap 128 between the first portion 130 and second portion 132. In one embodiment implant body is formed of a titanium alloy or stainless steel.

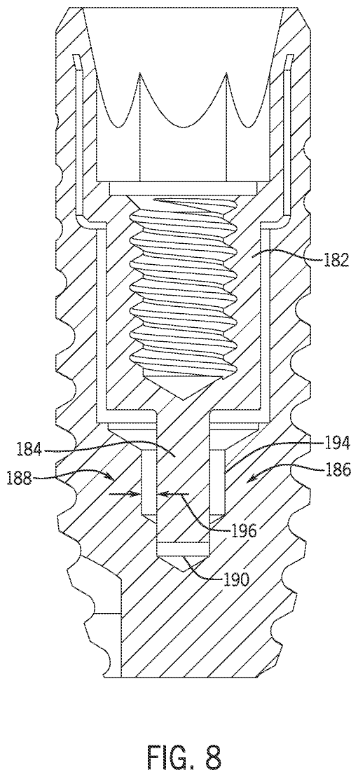

Referring to FIG. 8 in one embodiment insert 180 has a first portion 182 with geometry similar to first portion 130 described herein with the addition of an extension member 184 extending into a second portion 186 with geometry similar to second portion 132 with the addition of an apical cavity 188 that receives extension member 184 therein. Apical cavity includes a bottom 190, a bearing portion 192 a transition portion 194.

In extension member 184 acts to reduce the movement of first portion 182 with respect to outer portion 186 upon the application of a force to implant 180. In one embodiment extension 184 member is integral with first portion 182 and has a cylindrical geometry. The diameter of extension member 184 and bearing portion 192 have a geometry that permits extension member 184 to slide along the longitudinal axis 200 of implant body 180 relative to the second portion 186 upon an application of external load parallel to the longitudinal axis 200. Extension member 184 may bend about the longitudinal axis 200 to allow first portion 182 to move relative to second portion 186 in a non-parallel vector direction to longitudinal axis 200. Extension member 184 provides additional stiffness and resistance to external loads applied to implant 180 that are non-parallel to longitudinal axis 200. In one embodiment a gap 196 between the transition portion 194 and extension member 184 is greater than the gap between the bearing portion 192 and extension member 184.

In one embodiment first portion 182 can move relative to second portion 186 in a direction along longitudinal axis 200 a first distance less than a second distance that at least a region of first portion 182 can move relative to second portion 186 in a vector direction perpendicular to longitudinal axis 200.

In one embodiment first portion 182 and second portion 186 of implant 180 are formed of one of titanium, titanium alloy and stainless steel. As described above with respect to implant 110 first portion 182 moves relative to second portion 186 about a pivot zone 198. In one embodiment pivot zone 198 is in the coronal portion of the implant 180.

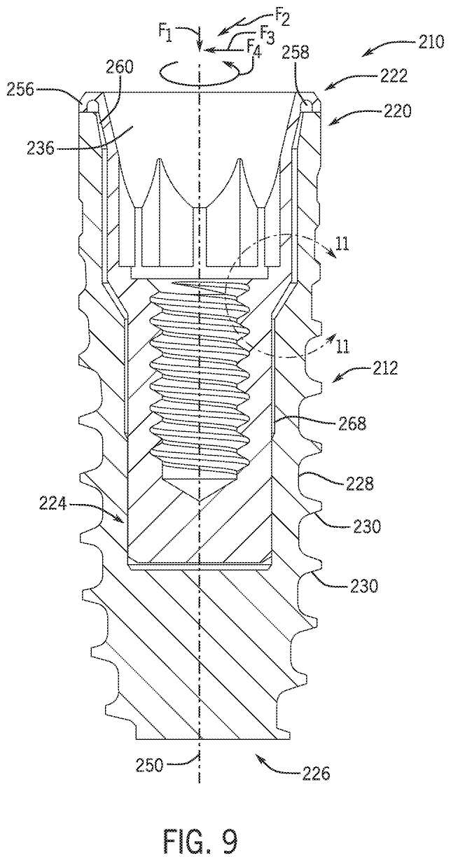

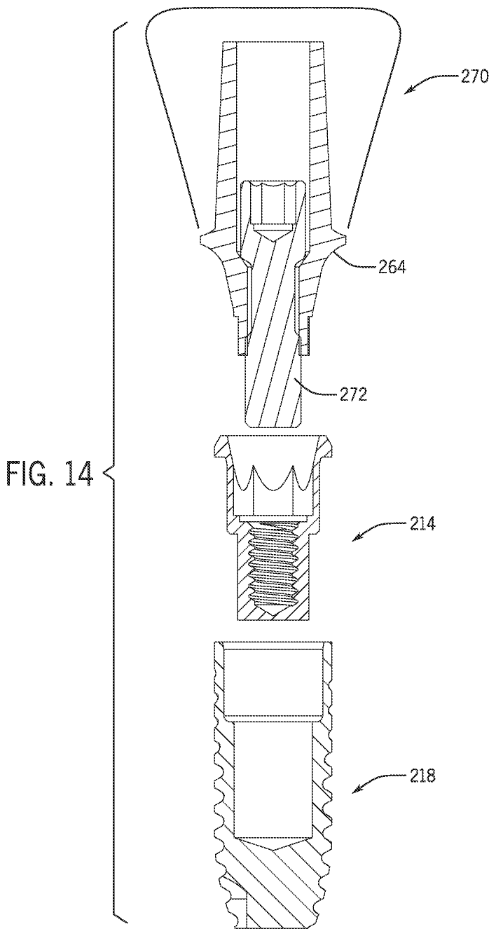

Referring to FIG. 9-FIG. 14 in one implementation implant 210 includes an implant body 212 formed from a first portion 214 received within a cavity 216 of a second portion 218. First portion 214 is hermetically sealed to second portion 218 at a coronal interface 220 proximate a coronal end 222 of implant body 212. Coronal interface 220 includes a first area 220a on first portion 214 and a second area 220b on second portion 218. First area 220a is located proximate the coronal end of first portion 214 and defines a circumferential surface that faces toward the apical end of the implant body 212. The first area 220a is the terminal end of a lip 256 extending from the coronal end toward the apical end of the first portion 214. An upper gap 258 is defined as the space between the lip 256 and an outer wall 260 of first portion 214. In one implementation first portion 214 is further secured to second portion 218 at an apical region 224 of cavity 216. Lip 256 includes a first portion 256a proximate an outer surface being furthest from the longitudinal axis 250 of implant body 212 and extending generally parallel to longitudinal axis 250 and a second portion 256b extending radially outward from longitudinal axis 250 and defining the coronal end of implant body 212

Implant body 212 has a coronal end 222 and an opposing apical end 226. In one implementation first portion 214 is secured to second portion 218 proximate the coronal end 222 of implant body 212. Implant body 212 has an outer surface 228 including outer threads 230. Implant body 212 includes a head region 232 having an opening 234 into a compartment 236 that extends from the coronal end 222 into implant body 212 toward the apical end 226.

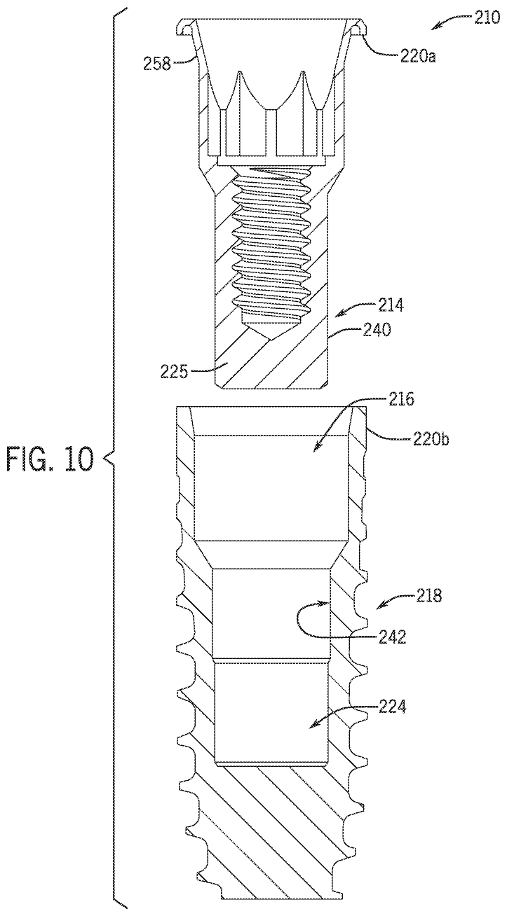

A continuous gap 238 is defined by the space between the outer wall 240 of first portion 214 and the cavity wall 242 of cavity 216 of second portion 218. In one implementation gap 238 is circumferentially positioned within implant body 212 and radially spaced from the outer surface 228 and radially spaced from compartment 236. Referring to FIG. 10 gap 238 includes a first region 244, a second region 246, and a third region 248. Each gap portion is defined by a portion outer wall 240 of first portion 214 and cavity wall 242 of cavity 216. First region 244 terminates proximate the coronal end 22 of implant body 212 at the upper gap 258. Gap 238 as used herein includes upper gap 258. There is no gap between the apical region 224 of cavity 216 and the Outerwall of the apical portion of first portion 214. Referring to FIG. 10 the diameter of the apical region 224 is less than the diameter of the region adjacent thereto and closer to the coronal end. In one implementation where the implant body is formed from two separate portions, the first portion and second portion may provide an interference fit in the apical region. In one implementation the apical portion 224 of cavity 216 and the apical portion 225 of first portion 214 are welded together to eliminate any gap in the apical region. In one implementation the implant body is 3D printed as a unitary component and no gap in the apical portion of the implant body 212.

In one implementation the distance between the outer wall 240 of first portion 214 and the cavity wall 242 of cavity 216 is between 0.02 mm and 0.5 mm. The distance between outer wall 240 and cavity wall 242 is measured radially in a direction perpendicular to the longitudinal axis 250 of implant 210. In one implementation upper gap 258 is the same distance as the first region 244 of gap 238. In one implementation upper gap 258 has a distance between 0.02 mm and 0.5 mm and is greater than gap 238 at first region 244. In one implementation first region 244 aligns with head region 232 along a longitudinal axis 250 of implant 210. Third region 248 aligns with an internal threaded 252 region of compartment 236. Second region 246 is a transition between the first region 244 and the third region 248. Wherein the distance between the first portion of compartment 236 and the outer surface is less than the distance between the third region of compartment 236 and the outer surface 228. In one embodiment the distance of the gap 238 tapers from a first distance at the coronal region of gap 238 to a second distance at the apical region of gap 238 where the second distance is less than the first distance. In one implementation the taper is continuous such that the distance of gap 238 is continuously reduced from the coronal region of gap 238 toward the apical region of gap 238. In one implementation gap 238 tapers from the coronal end of gap 238 to the apical end of gap 238. In one implementation the radial distance of gap 238 is substantially similar from the coronal region to the apical region. In one implementation the radial distance of gap 238 varies from the coronal region to the apical region. In one implementation the thickness T1 of the first portion 214 between upper gap 258 and an upper terminal surface 262 at the coronal end of implant body 212 is between 0.02 mm and 0.3 mm. In one implementation the thickness T2 of lip 256 is between 0.05 mm and 0.3 mm.

Gap 238 includes a coronal end, in contrast to implant 110, gap 238 does not include a bottom most portion extending perpendicular to longitudinal axis 250.

Referring to FIG. 2 the first portion 130 and second portion 132 are each formed from one of stainless steel, titanium and a PEEK (polyether ether ketone) polymer. In one implementation first portion 130 and second portion 132 are formed from the same material. In one implementation first portion 130 and second portion 132 are formed from different materials. In one implementation gap 128 is free from a solid material. In one implementation gap 128 is filled with a material different from the material of the first portion and the second portion such as silicon or a fluoroelastomer such as Viton having a lower viscosity than the material of the first portion and the second portion allowing for a change of the geometry of the gap upon an application of a force to the compartment as discussed herein.

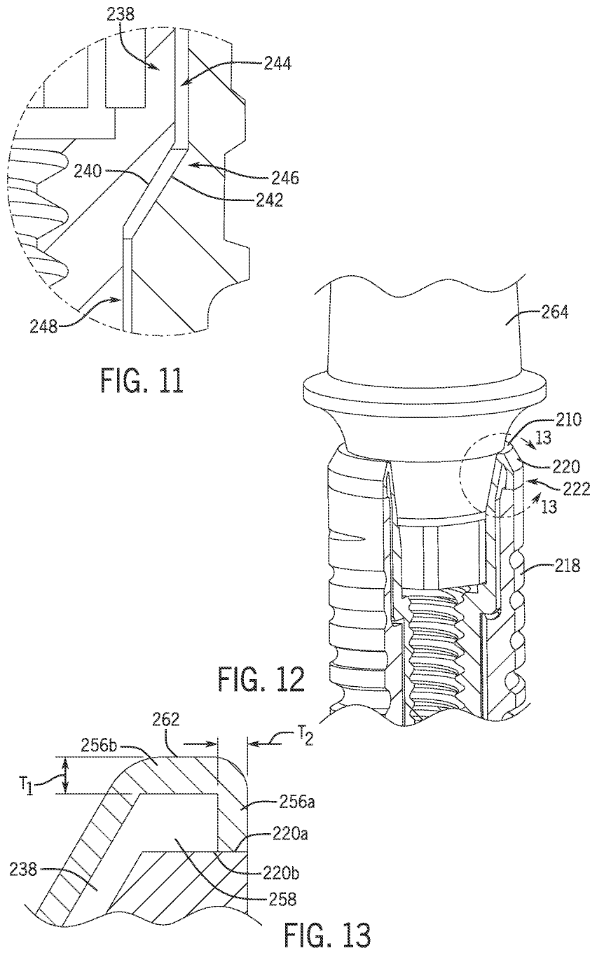

Referring to FIG. 10 and FIG. 11 gap 238 is defined by outer wall 240 of first portion 214 and cavity wall 242 of second portion 218. Stated another way the surface of the gap closest to the longitudinal axis of implant body 212 in a direction perpendicular to the longitudinal axis is outer wall 240 of first portion 214 and the surface of gap 238 further from the longitudinal axis in a direction perpendicular to the longitudinal axis is cavity wall 242. The outer wall 240 of the first portion 214 defines the inner surface of gap 238 as defined above.

Referring to FIG. 8 first portion 182 and the second portion 186 of implant 180 are each formed from one of stainless steel, titanium and a polymer. In one implementation first portion 182 and second portion 186 are formed from the same material. In one implementation first portion 182 and second portion 186 are formed from different materials. In one implementation gap 196 is free from a solid material. In one implementation gap 196 is filled with a material different from the material of the first portion and the second portion such as silicon or Viton.

Referring to FIG. 9 first portion 252 and the second portion 254 of implant 180 are each formed from one of stainless steel, titanium and a polymer. In one implementation first portion 252 and second portion 254 are formed from the same material. In one implementation first portion 252 and second portion 254 are formed from different materials. In one implementation gap 238 is free from a solid material. In one implementation gap 238 is filled with a material different from the material of the first portion and the second portion such as Silicon or Viton.

As described above, a living tooth has a root which rests in the periodontal membrane, located between the root of the tooth and the jawbone that acts as a shock absorber and has a damping effect on the impact force which the tooth receives. Since a dental implant is connected directly to the jawbone without the benefit of the periodontal membrane the implants 110 and 180 as described herein provide the shock absorber function by allowing movement of the first portion relative to the second portion upon the application of a force to the implant.

Compartment 236 includes an anti-rotational feature like a bevel surface, internal threads, a hexagon shape or any other anti-rotational shape to receive abutment 264 therein and prevent rotation of abutment 264 relative to compartment 236. A prosthetic tooth such as a crown 270 is affixed to the coronal end of abutment 264. A fastener 272 includes threads (not shown) that is threadedly received within a threaded apical portion of compartment 236 to secure abutment to implant body 212. Internal threads 266 of first portion 214 are used to securely position abutment 264 within compartment 236. Crown 270 as is known in the art is secured to abutment 264.

A force applied to crown 270 is transferred to the first portion 214 of implant 210. As discussed above with respect to implant 110 the force may be applied in a vector F1 direction parallel to a longitudinal axis 250 of the implant body 212 or may be applied in a vector direction F2 non-parallel to the longitudinal axis 250 at a non-perpendicular angle to longitudinal axis 250. Force F may also be in a direction F3 perpendicular to longitudinal axis 26 or any combination of vectors F1, F2 and F3. A force F4 may also be about longitudinal axis 250. Upon the application of the force first portion 214 moves about a bending region 268 relative to second portion 218 by deformation of a region proximate upper gap 258. Bending region 268 is located at the distal apical end of gap 238 while the deformation region 222 is located at the coronal portion of implant body 212. In contrast a force applied to implant 110 and implant 180 discussed above both deforms and bends at the same coronal region.

Upon the application of an external force to the prosthetic tooth, abutment 264 and the prosthetic tooth moves with the first portion 214 relative to the outer wall of the second portion 218. In this manner the external force is absorbed by the movement of the first portion 214 relative to the second portion. In one implementation during this movement there is no movement between abutment 264 and the first portion 214. When the force is removed from the prosthetic tooth, the first portion returns to the original relaxed non-stressed position relative to the second portion. In this manner the implant body acts as a shock absorber to external forces applied to the prosthetic tooth. The implant body behaves as a spring such that the first portion moves back to an equilibrium position once the external force is removed from the prosthetic tooth.

First portion 214 is welded to and hermetically sealed with respect to second portion 218 such that when region about upper gap 258 deforms no foreign material can enter upper gap 258 and any region of gap 238. The connection between first portion 214 and second portion 218 closes upper gap 258 and gap 238 from any interaction with the outside environment. In one implementation first portion 214 is welded to second portion 218 hermetically sealing gap 238 and upper gap 258 so that no foreign matter can enter into the gap. Although upper gap 258 and gap 238 are identified with different reference numerals in one implementation upper gap 258 and gap 238 are in fluid communication with one another. The region surrounding upper gap 258 acts as a living hinge allowing first portion to move relative to the second portion upon the application of a force to the prosthetic tooth. In one embodiment the welded connection between the first portion and the second portion is at the coronal end of the implant body 212. Stated another way first portion 214 bends relative to second portion 218 proximate upper gap 258 as the region about upper gap 258 deforms in response to the application of force to the prosthetic tooth.

In one implementation implant body 212 is a single component that cannot be disassembled. The welding of first portion 214 and second portion 218 to one another creates a single integral component that cannot be dissembled. In one implementation implant body 212 is formed by 3d printing forming a single integral component that includes the closed hermetically sealed gap 238 and upper gap 258 described herein. 3D printing of implant body 212 can use metal materials. 3D printing known in the art can also use other biocompatible materials. Biocompatible materials that provide sufficient deformation properties of the deformation region allowing the walls defining compartment to move relative to the external surface of implant body 212 may be used.

The regions of gap 238 are in fluid communication with each other and are closed to the exterior of implant body 212 such that no material either solid, fluid, or in the form of a gas can enter gap 238 from outside of the implant body 212. As a result, gap 238 is hermetically sealed with respect to any material outside of implant body 212. Gap 238 are hermetically sealed such that the gap is secure against the entry of microorganisms external to the implant body 212.

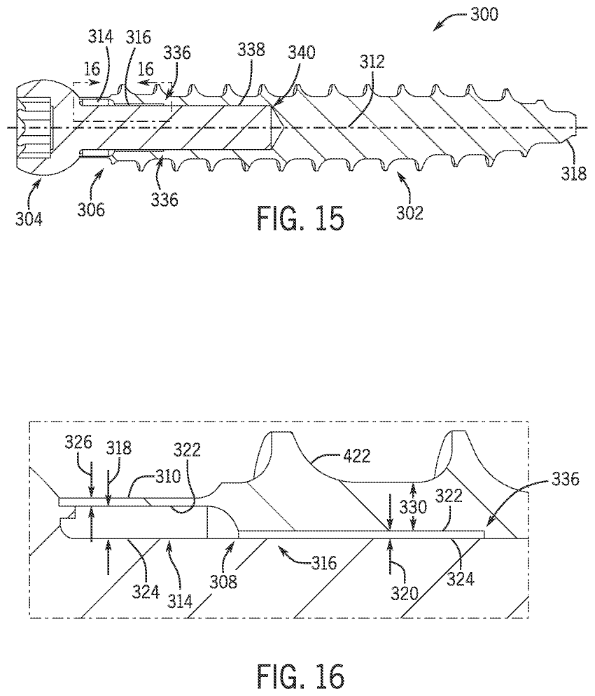

Referring to FIG. 15-FIG. 17 an orthopedic fastener 300 is secured to a vertebra (bone) of a patient. Fastener 300 includes a body having an externally threaded portion 302, a head 304 and a neck portion 306 intermediate body 302 and extended head 304. In one implementation fastener 300 is a unitary member either formed by welding two or more components together or by 3d printing as is known in the art using metal material or other biocompatible materials.

Fastener 300 includes a circumferential gap 308 positioned intermediate an outer wall 310 of fastener 300 and a longitudinal axis 312 of the fastener. Gap 308 defines a closed hermetically sealed space having a first region 314 and a second region 316. First region 314 is located proximate head 304 within neck portion 306 and is in fluid communication with second region 316. Second region 316 extends from first region 314 extending in a direction toward a distal tip 318 of threaded body 302. First region 314 of gap 308 has a first distance 318 in the direction perpendicular to the longitudinal axis 312 that is greater than a second distance 320 of the second region 316 perpendicular to the longitudinal axis 312. Gap 308 is defined by an outer wall 322 and an inner wall 324. The distance 326 between of the outer wall 322 defining gap 308 proximate the first region 314 and the outer wall 310 of the neck portion is less than the distance 330 between the outer wall 322 of the gap proximate the second region and the outer wall 332 of the threaded portion 302.

When the threaded portion 302 of fastener 300 is secured to a patient's bone head portion 304 and neck portion 306 extend outside of the patient's verera. In an equilibrium position in which no external force is acting on the head 304 of the fastener 300 the geometry of gap 308 is equally spaced about the longitudinal axis 312. Upon an application of a force to the head 304 the head moves relative to the threaded portion by deformation of 322 the fastener body proximate the first region 314 of gap 308 and bending of bending region proximate the distal end of gap 308. The second region 316 of gap 308 extends a predetermined distance toward the distal tip 318 defining a distal end 336 of gap 308. Upon the application of a force to head 304 the fastener body deforms proximate the first region 314 of gap 308 and the neck portion and head 304 bend about a bending region adjacent the distal end 336 of gap 308.

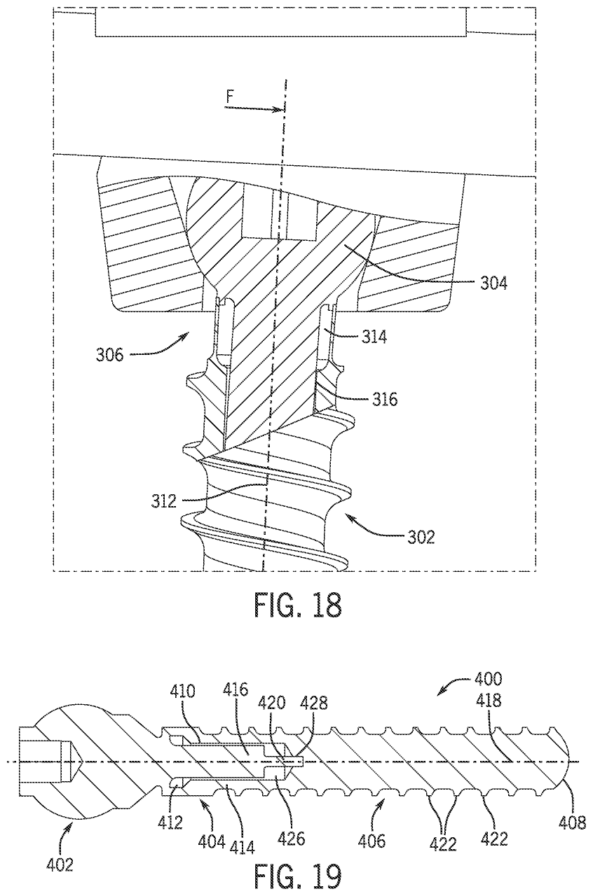

As a result, the geometry of gap 308 changes in response to the application of the force to head 304. Referring to FIG. 18 upon an application of a force F the distance between the walls defining gap 308 is not equal about longitudinal axis 312 in a direction perpendicular to longitudinal axis 312. Upon the removal of the external force F to head 304 the geometry of gap 308 returns to the original equilibrium position. In this manner fastener 300 provides a shock absorbing property.

In one implementation fastener 300 is manufactured as discussed above with respect to dental implant body 210 by two or more parts welded together, or via 3D printing with a metal or biocompatible material. In one implementation a first portion of fastener 300 is fit within a cavity of a second portion of fastener 300. The cavity having a cavity bottom 340. The geometry of an outer wall of the first portion of fastener 300 and the geometry of a cavity wall defining the cavity of the second portion are such that when a distal portion of the first portion is placed within the cavity of the second portion gap 308 is formed. The region of fastener 300 distal end 336 of gap portion 316 of gap 308 does not create any gap. In one implementation a distal region 338 of the first portion distal the distal end 336 of gap portion 316 is welded to the second portion ensuring there is no gap in the region of fastener 300 distal to distal end 336 of gap 308. The distal direction is the direction away from the free end of head 304 along longitudinal axis 312. A deformation region is formed proximate first portion 314 of gap 308 and a bending region is formed about the distal end of gap 336 as described above with respect to implant body 210. Such that upon an application to head 304 head 304 moves relative to the threaded portion 302 by deformation of the deformation region and bending about the bending region proximate the distal end of gap 336. Fastener 300 may be formed from materials as discussed herein with respect to implant body 212.

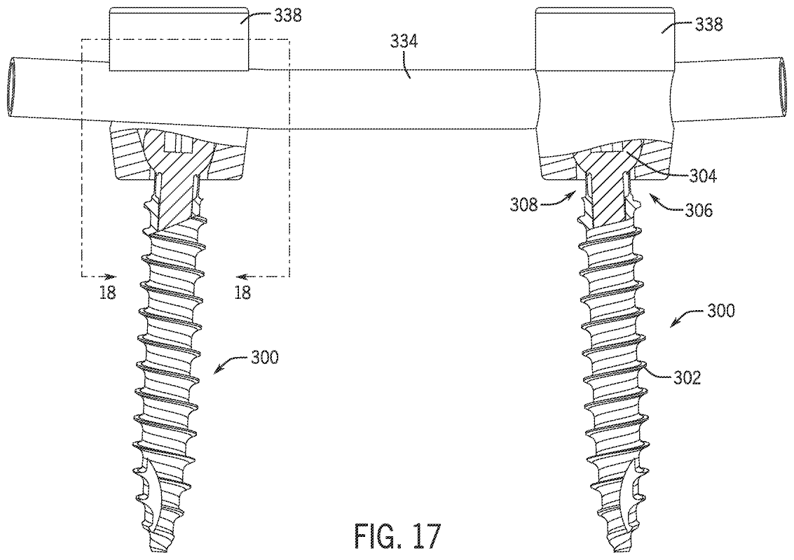

Referring to FIG. 17 fastener 300 can be used in an orthopedic system in which a first fastener 300 and a second fastener are secured to the same or different bones of a patient. A rod 334 is secured to the extended heads of each of the first and second fasteners and secured thereto with a tulip connector as is known in the art. In one implementation one or both of the fasteners are preloaded with a force such that at least one of the fasteners are in a non-equilibrium position. When the two bones being connected via the rod 334 move sufficiently toward one another the pre-loaded fastener will move to the equilibrium position and will only move away from the equilibrium position upon the application of an external force to head 304.

Referring to FIG. 19 another fastener 400 includes a head 402, a neck 404 and a threaded body 406 terminating in a distal tip 408. Fastener 400 includes a gap 410 including an upper region 412 proximate neck 404 and a second region 414 in fluid communication with upper region 412 and extending in a direction toward distal tip 408. Gap 410 defines a closed hermitically sealed space preventing from any material external to the fastener 400 to enter into gap 410 such as biological material. Fastener 400 is manufactured as described herein with the other implants and fastener 300 and may be formed from the same materials described with respect to fastener 300.

Fastener 400 includes an extension member 416 extending from head 402 through neck 404 into a cavity 426 within threaded body 406. Gap 410 is defined as the space between extension member 416 and the wall defining cavity 426. Upper region 412 of gap 410 defines a space having a first distance extending radially outward from and perpendicular to a longitudinal axis 418 of fastener 400. Second region 416 of gap 410 defines a space having a second distance extending radially outward from and perpendicular to a longitudinal axis 418 of fastener 400 that is less than the first distance. In one implementation extension member 416 includes a second extension member 420 extending therefrom in a direction toward distal tip 408 and being received in a second cavity 428 acting as a bearing surface for second extension member 420. The function and operation of second extension member 420 is similar to the extension member 184 of implant body 180 describe above.

Fastener 400 similar to fastener 300 is secured to a patient's bone via the threaded screw portion 422 on threaded body 406. Fastener 400 may also be used in an orthopedic system to affix a rod between portions of a bone or between bones such as spinal vertebrae. Similar to fastener 300 upon the application of a force to head 402 the geometry of gap 410 changes from a non-stressed or equilibrium position to a different geometry. This occurs by deformation of the fastener body proximate the upper region 412 of gap 410. However, since the extension member extends within cavity 426 and second cavity 428 while deformation of the fastener outer wall occurs proximate the upper region 412 of gap 410 the head and extension member also bend at the same region. Similar to fastener 300 the thickness of the outer wall of the fastener body proximate the upper region 412 of gap 410 is sufficiently thin to allow for deformation of the fastener body at that region to allow head 402 to move relative to the threaded body 406 that is affixed to the patient's bone. In one implementation the thickness of the wall is sufficient to allow for movement of head 402 in response to 500 N of force applied to head 402 without the walls defining gap 410 from contacting one another. This feature applies to all of the implants and fasteners discussed herein.

In one implementation fastener 300 and fastener 400 are used and may be used in dynamic spinal stabilization systems to attach rods between spinal vertebrae. However, fastener 300 and fastener 400 are also used wherever bones are joined in a surgical procedure. Fastener 300 and fastener 400 provide both a shock absorbing feature as well as the ability to preload the fastener to assist in biasing bones toward one another to maintain flexibility. Implants 110 and 210 include a coronal portion which may also be described as a proximal portion and a threaded portion that is designed to be embedded into a jaw of a patient. The coronal or proximal portion is not fully embedded into the jaw in an in-use position and exposed from the jaw. For example, at least a portion of the implant used in a dental procedure has an exposed portion that receives the prosthetic abutment and/or crown. Similarly, fastener 300 and fastener 400 include a head that may also be referred to as a proximal portion as the head extends from and outside a bone of a patient when the threaded portion is embedded into the bone of a patient. Implants 100, 210 and fasteners 300 and 400 may be referred to generically to by the term implant as a portion of implants 100, 210 and fasteners 300, 400 are implanted into a bone of a patient.

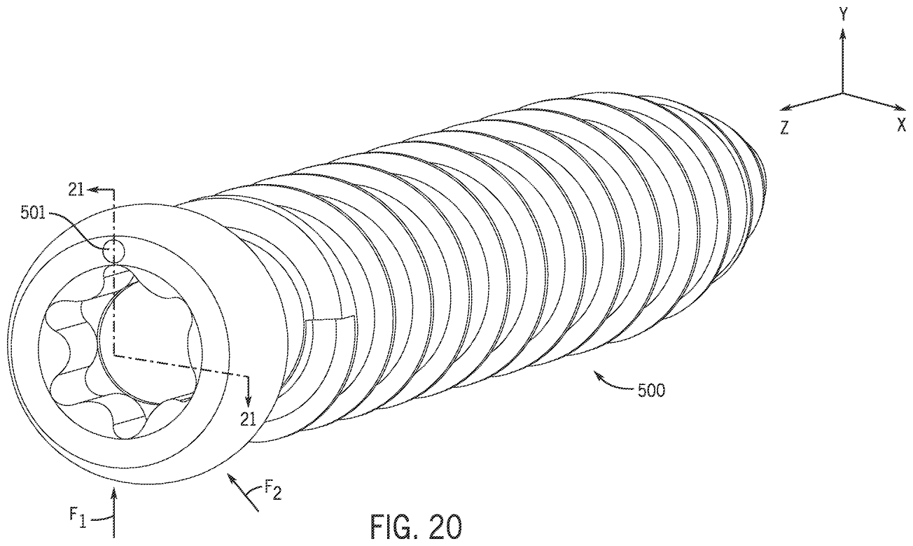

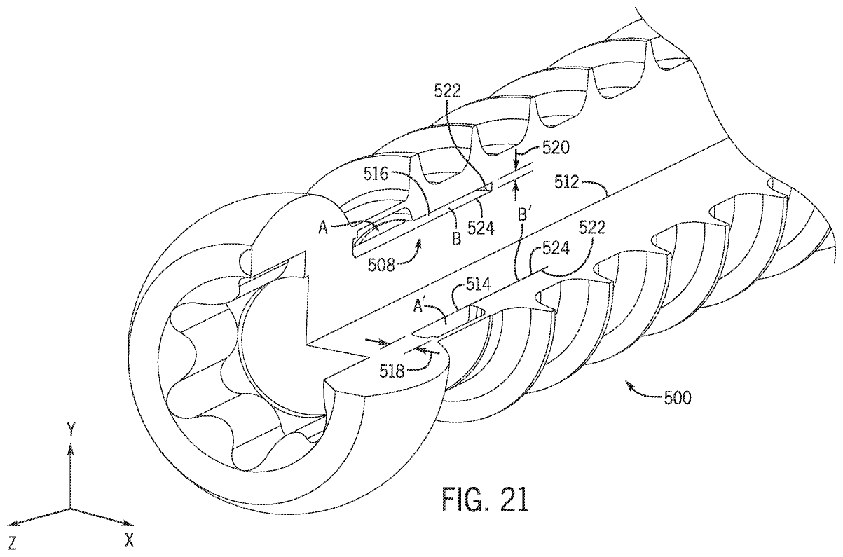

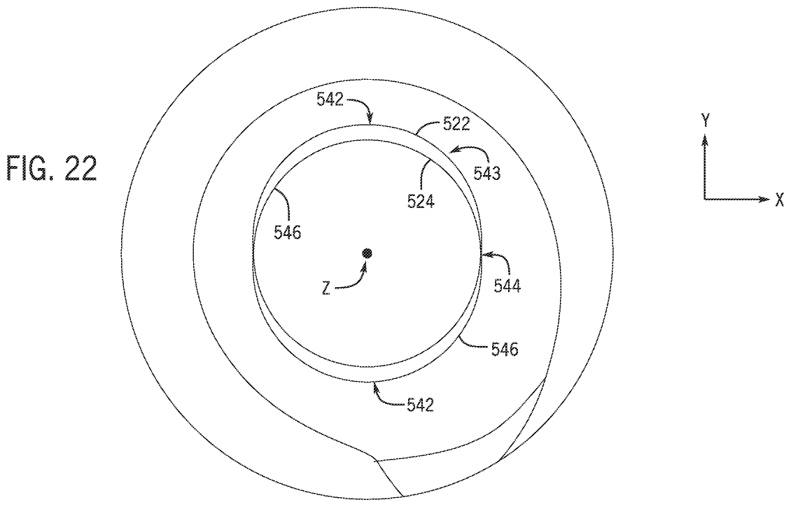

Referring to FIG. 20, FIG. 21 and FIG. 22 an orthopedic fastener 500 is similar to fastener 300 with the exception that the gap 508 is not uniform about the longitudinal axis 512 of the fasteners. To allow for comparison of features orthopedic fastener 500 will be identified with reference numerals similar to the reference numerals used with fastener 300 but offset by 200. Fastener Gap 508 includes a first region 514 and a second region 516. In one implementation second region 516 defines a gap 508 that is not uniform about the longitudinal axis 512 of fastener 500 but rather has a first distance 520 along a first Y axis perpendicular to longitudinal Z axis 512 that tapers to a second distance 521 along a X axis perpendicular to both the X axis and the longitudinal axis.

In one implementation the outer wall 522 of second region 516 of gap 508 forms an oval shape about longitudinal axis 512, while an inner wall 524 of gap 508 forms a circular shape. In this implementation the outer wall 524 and inner wall 522 are in contact along the X axis. Stated another way there is no gap 316 along the X axis. Referring to FIG. 22 the distance 520 of gap 508 decreases about the longitudinal axis 512 from the Y axis toward the X axis. In this implementation gap 508 is greatest along the Y axis and is progressively smaller as measured radially along a vector perpendicular to longitudinal axis 512. Referring to FIG. 22 gap 508 is greatest along the Y axis at point 542. The distance of gap 508 at a point 543 between the Y axis and the X axis is less than the gap 508 at point 542. While outer wall 522 is shown as being oval and the inner wall 524 is shown as circular or a circle other geometric shapes may be used. It is also contemplated that shape of the outer wall 522 and inner wall 524 are varied such that there will be a region between the Y axis and the X axis where the distance 520 of gap 508 will be the same.

Referring to FIG. 20 when a force F1 is applied along the Y axis the head bends only in the Y direction, however when a force is applied along the X axis the head will not bend relative to the longitudinal axis 512. When a Force F2 is applied in a direction between the Y axis and the X axis the head will only bend in the Y direction.

In one implementation first region 514 of gap 308 that is uniform 360 degrees about longitudinal axis 512. In another implementation first region 514 is not uniform 360 degrees about longitudinal axis but varies. In one implementation first region 514 of gap 508 has a distance 518 is greatest along the Y axis and less along the X axis.

Fastener 500 includes an indicia 501 on the head on the Y axis that provides a visual indication of the direction that the head is able to flex relative to the longitudinal axis 512.

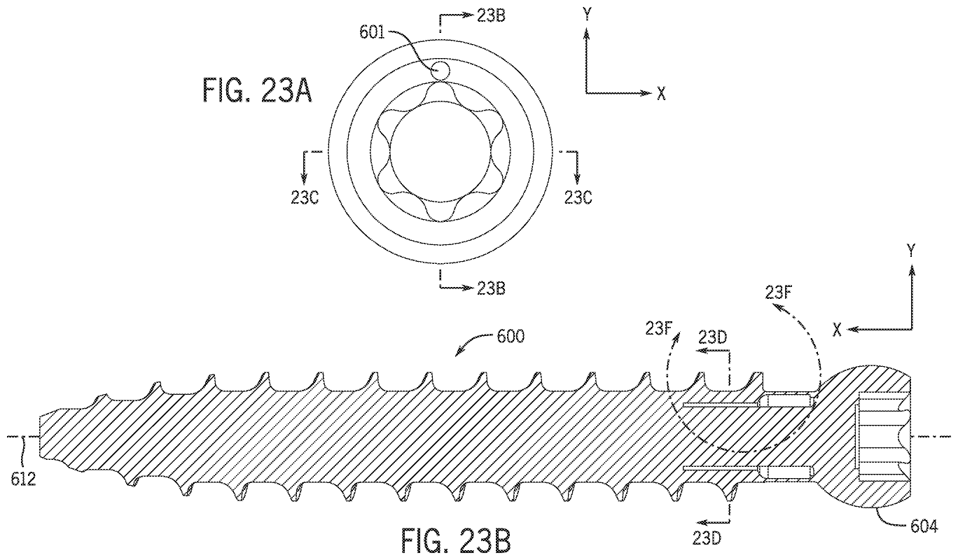

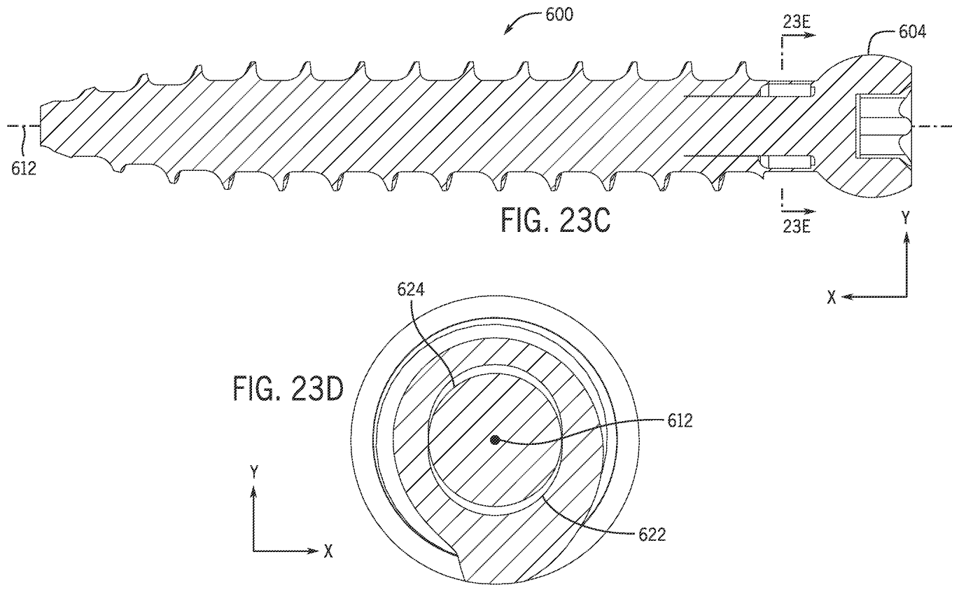

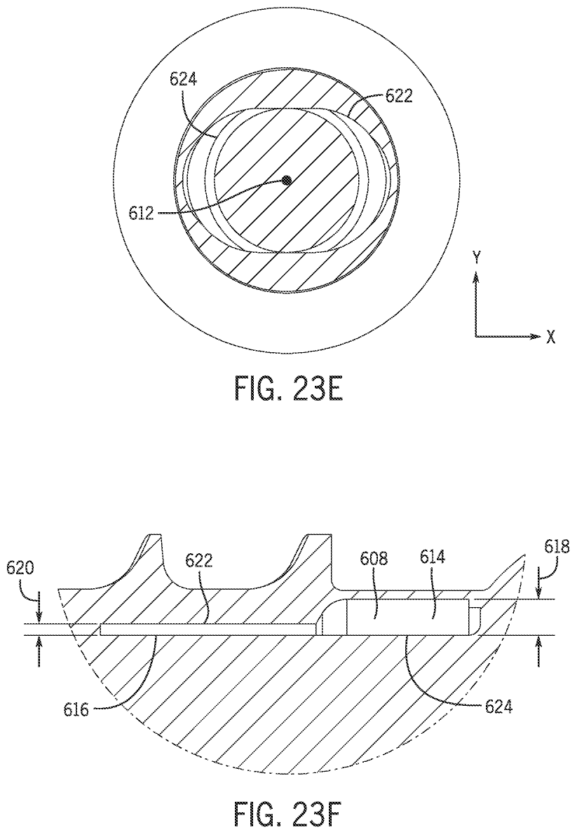

Referring to FIG. 23A-23F an orthopedic fastener 600 is similar to fastener 500 and 300 with the exception that the gap 608 is not uniform about the longitudinal axis 612 of fastener 600 for both a first region 614 of gap 608 and second region 616 of gap 608.

Fastener Gap 608 includes a first region 614 and a second region 616. In one implementation both first region 614 and second region 616 define a gap 608 that is not uniform about the longitudinal axis 612 of fastener 600. First region 614 has a gap with a first distance 618 along a Y axis perpendicular to longitudinal Z axis 612 that tapers to a second distance 621 along a X axis perpendicular to both the Y axis and the longitudinal Z axis 612. Similarly, second region 616 has a first distance 620 that tapers to a second distance 623 along an X axis perpendicular to both the Y axis and the longitudinal Z axis 612.

In one implementation the outer wall 622 of first region 614 and second region 616 of gap 608 form an oval shape about longitudinal axis 612, while an inner wall 624 of gap 608 forms a circular shape. In this implementation the outer wall 624 and inner wall 622 are in contact along the X axis in the first region 614 and the second region 616 along the X axis. Stated another way there is no gap 308 along the X axis. Referring to FIG. 23D and FIG. 23E the distance of gap 608 decreases about the longitudinal axis 612 from the Y axis toward the X axis. In this implementation gap 608 is greatest along the Y axis and is progressively smaller as measured radially along a vector perpendicular to longitudinal axis 612.

Referring to FIG. 23D and FIG. 23E gap 608 is greatest along the Y axis at point 642. The distance of gap 608 at a point 643 between the Y axis and the X axis is less than the gap 608 at point 642. While outer wall 622 is shown as being oval and the inner wall 624 is shown as circular or a circle other geometric shapes may be used. It is also contemplated that shape of the outer wall 622 and inner wall 624 are varied such that there will be a region between the Y axis and the X axis where the distance 520 and 516 of gap 508 will be the same.

Similar to the discussion regarding fastener 500 when a force F is applied along the Y axis the head 604 bends only in the Y direction, however when a force F is applied along the X axis the head 604 will not bend relative to the longitudinal axis 612. When a Force F is applied in a direction between the Y axis and the X axis the head 604 will bend mainly in the direction of the Y axis with no movement directly along the X axis.

Fastener 600 includes an indicia 601 on the head 604 on the Y axis that provides a visual indication of the axis along which the head 604 is able to flex relative to the longitudinal axis 612.

In another implementation a fastener may have a tapered gap only 180 degrees about the longitudinal axis with the other 180 eighty degrees being in contact or close contact. In this implementation the head of the fastener would be movable from the longitudinal axis in a single direction such as the +Y axis from the longitudinal Z axis.

The head 304 of fastener 304 has the ability act as a shock absorber 360 degrees about the longitudinal axis 312. Head 304 will be in alignment with longitudinal axis 312 as defined when fastener 300 is in an un-stressed condition. In contrast when a force is applied to head 304 in a direction non-parallel to the longitudinal axis head 304 will bend the rest of the fastener body.

Fastener 500 and fastener 600 except as described is similar in all other respects to the fastener 300 and the method of manufacture described with respect to fastener 300. When a force is applied to head 504 of fastener 500 and head 604 of fastener 600 the head will not move from the longitudinal axis if that Force is applied in a radial direction in which the distance of gap 508 and gap 608 has a distance of zero. Stated another way head 504 and head 604 will move from the longitudinal axis of fastener 500 and fastener 600 respectively only in radial direction perpendicular to the radial direction in which the gap has a distance of zero. However head 504 and head 604 can move in a positive or negative direction along a given axis perpendicular to the longitudinal axis 512 and axis 612 of fastener 500 and fastener 600 respectively.

It is also contemplated that outer wall 622 is distanced from the inner wall 624 only 180 degrees about the longitudinal axis in which case head 604 can only move away from and back to the longitudinal axis upon an application along a line defined from one direction from the longitudinal axis. It is also contemplated that the gap 608 varies 360 degrees about the longitudinal axis such that movement of head 604 is possible in all directions but greater in certain directions than in other directions.

In some aspects, the techniques described herein relate to a dental implant including: an implant body having a coronal end and an apical end opposite the coronal end, an outer surface, and a compartment extending therein from the coronal end toward the apical end, the implant body including a gap between the compartment and the outer surface, wherein the gap is a closed hermitically sealed space.

In some aspects, the techniques described herein relate to a dental implant, wherein the compartment is defined by an internal surface being movable with respect to the outer surface of the implant body by deformation and flexibility of the implant body in a region closer to the coronal end than the apical end.

In some aspects, the techniques described herein relate to a dental implant, wherein the gap extends circumferentially about a longitudinal axis of the implant body defined by an inner surface being closer to the longitudinal axis of the implant body and the outer surface of the implant body.

In some aspects, the techniques described herein relate to a dental implant, wherein a radial distance between the inner surface of the gap to the outer surface of the gap tapers from a first distance proximate the coronal end to a second distance less than the first distance distal the coronal end.

In some aspects, the techniques described herein relate to a dental implant, wherein the implant body includes a first portion including the compartment, and a second portion, the first portion and the second portion being connected by a transition zone in a coronal region of the implant body that deforms upon an application of force to the first portion allowing the first portion to move relative to the second portion, wherein the gap is located between the first portion and the second portion.

In some aspects, the techniques described herein relate to a dental implant, wherein the first portion is welded to the second portion at the transition zone and wherein the gap is formed between the first portion and the second portion.

In some aspects, the techniques described herein relate to a dental implant, wherein the first portion is formed from a first material including one of stainless steel, titanium and a polymer.

In some aspects, the techniques described herein relate to a dental implant, wherein the second portion is formed from a second material different than the first material.

In some aspects, the techniques described herein relate to a dental implant, wherein the first portion and the second portion are formed from the same first material.

In some aspects, the techniques described herein relate to a dental implant, wherein a space defined by the gap includes a gap material different than a first material of the first portion and a second material of the second portion.

In some aspects, the techniques described herein relate to a dental implant, wherein a space defined by the gap is free of a nongaseous material.

In some aspects, the techniques described herein relate to a dental implant, wherein the first portion is movable relative to the second portion in a radial direction generally perpendicular to the longitudinal axis of the implant body.

In some aspects, the techniques described herein relate to a dental implant, wherein the first portion is movable relative to the second portion in a direction generally along the longitudinal axis of the implant body.

In some aspects, the techniques described herein relate to a dental implant, wherein the first portion is movable relative to the second portion in a rotational direction about the longitudinal axis of the implant body.

In some aspects, the techniques described herein relate to a dental implant, wherein the implant body is made from one piece and formed in a 3D printing process.

In some aspects, the techniques described herein relate to a dental implant, further including a prosthetic abutment having an apical portion received within the compartment and an opposing coronal portion.

In some aspects, the techniques described herein relate to a dental implant, further including a prosthetic crown secured to the coronal portion of the abutment.

In some aspects, the techniques described herein relate to a dental implant, wherein the compartment moves about a bending region proximate an apical end of the gap in response to an application of a force to the prosthetic crown.

In some aspects, the techniques described herein relate to a dental implant, wherein the first portion includes an extension member extending into an apical cavity of the second portion.

In some aspects, the techniques described herein relate to a dental implant, wherein the second portion includes a bearing surface that allows the first portion and the extension member to move along the longitudinal axis of the implant body, while restricting movement of the extension member in a direction perpendicular to the longitudinal axis.

In some aspects, the techniques described herein relate to a dental implant, wherein the gap is symmetrical about a longitudinal axis of the implant body and has a first geometry in an equilibrium position and a second geometry different than the first geometry in a non-equilibrium position upon an application of an external force to the prosthetic crown, the gap returning to the first geometry from the second geometry when the external force is removed from the prosthetic crown.

In some aspects, the techniques described herein relate to a dental implant, wherein the compartment includes an anti-rotational and internal thread features to receive an abutment or any other prosthetic component.

In some aspects, the techniques described herein relate to a dental implant including: an implant body having a coronal end and an opposing apical end, the implant body including a first portion connected to a second portion defining gap therebetween, the gap defining a closed hermetically sealed space, the second portion having an outer surface, and the first portion including a compartment extending therein from the coronal end toward the apical end; the first portion being movable relative to the second portion by deformation and flexibility of a region of the implant body changing a geometry of the gap; an abutment received within the compartment; and a prosthetic tooth secured to a member extending through the abutment and threadedly received in a threaded region of the compartment.

In some aspects, the techniques described herein relate to an orthopedic fastener including: a fastener body having a head, a neck, a threaded body and a distal tip, the fastener body including a hermetically sealed circumferentially extending gap between an outer surface of the fastener body and a longitudinal axis of the fastener body; the neck including a deformation region proximate the head that deforms upon an application of a force to the head allowing the head to bend relative to the longitudinal axis of the threaded body.

In some aspects, the techniques described herein relate to an implant including: a fastener body having an externally threaded region with a distal tip and a proximal portion having a proximal end furthest from the distal tip along a longitudinal axis of the fastener body, the fastener body including a hermetically sealed circumferentially extending gap between an outer surface of the fastener body and the longitudinal axis of the fastener body; the fastener body includes a deformation region closer to the proximal portion than the distal tip that deforms upon an application of a force to the proximal portion allowing the proximal portion to bend relative to the longitudinal axis of the threaded body.

In some aspects, the techniques described herein relate to an implant, wherein the externally threaded region is configured to be inserted into a vertebra (bone) of a patient in an in-use position and part of the proximal end remains exposed from the vertebra (bone) in an in-use position.

In some aspects, the techniques described herein relate to an implant, wherein the proximal portion includes an exposed compartment that receives a prosthetic abutment supporting a crown for use as a dental implant, wherein the bone is a jaw.

In some aspects, the techniques described herein relate to an implant, wherein the proximal portion includes a tool receiving compartment to permit rotation of the fastener body to secure the threaded region into the bone of a patient, wherein the bone is a spinal bone.

In some aspects, the techniques described herein relate to an implant, wherein the proximal portion of the fastener that has no bone fixation properties and extends outside the bone in-use position, the proximal portion includes a spherical or any other shape to be connected to an external instruments such as Tulip and a rod.

In some aspects, the techniques described herein relate to an orthopedic fastener including: a fastener body having a head, a neck, a threaded body and a distal tip, the fastener body including a hermetically sealed circumferentially extending gap between an outer surface of the fastener body and a longitudinal axis of the fastener body; the neck including a deformation region proximate the head that deforms upon an application of a force to the head allowing the head to bend relative to the longitudinal axis of the threaded body only along a single axis perpendicular to the longitudinal axis of the fastener body.

In some aspects, the techniques described herein relate to an orthopedic fastener, wherein a radial distance between an inner surface of the gap to an outer surface of the gap tapers from a first distance along a first direction perpendicular to the longitudinal axis to a second distance along a second direction perpendicular to the first direction and the longitudinal axis.

In some aspects, the techniques described herein relate to an orthopedic fastener, where in the second distance is zero.

In some aspects, the techniques described herein relate to an orthopedic fastener, wherein the head includes an indicia along the first direction spaced from the longitudinal axis.

In some aspects, the techniques described herein relate to an orthopedic fastener, wherein the inner surface forms a circle about the longitudinal axis and the outer surface forms an oval about the longitudinal axis.

In some aspects, the techniques described herein relate to an implant including: a fastener body having an externally threaded region with a distal tip and a proximal portion having a proximal end furthest from the distal tip along a longitudinal axis of the fastener body, the fastener body including a hermetically sealed circumferentially extending gap between an outer surface of the fastener body and the longitudinal axis of the fastener body; the fastener body includes a deformation region closer to the proximal portion than the distal tip that deforms upon an application of a force to the proximal portion allowing the proximal portion to bend relative to the longitudinal axis of the threaded region only along a single axis perpendicular to the longitudinal axis of the fastener body.

In some aspects, the techniques described herein relate to an implant, wherein a radial distance between an inner surface of the gap and an outer surface of the gap varies between a first direction perpendicular to the longitudinal axis and a second direction perpendicular to the first direction and the longitudinal axis.

In some aspects, the techniques described herein relate to an implant, wherein the radial distance tapers from a first distance along the first direction to zero along the second direction.

In some aspects, the techniques described herein relate to an implant, wherein the externally threaded region is configured to be inserted into a bone of a patient in an in-use position and part of the proximal end remains exposed from the bone in an in-use position.

In some aspects, the techniques described herein relate to an implant, wherein the proximal portion includes an exposed compartment that receives a prosthetic abutment supporting a crown for use as a dental implant.

In some aspects, the techniques described herein relate to an implant, wherein the proximal portion includes a tool receiving compartment to permit rotation of the fastener body to secure the threaded region into a bone of a patient, wherein the bone is a spinal bone.

In some aspects, the techniques described herein relate to an implant, wherein the proximal portion of the fastener that has no bone fixation properties and extends outside of a in an in-use position, the proximal portion includes a spherical or any other shape to be connected to an orthopedic system.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described is manifestly intended to be as broad as possible. For example, unless specifically otherwise noted, the definitions reciting a single particular element also encompass a plurality of such particular elements.

What is claimed is:

1. A dental implant comprising:
an implant body having a coronal end and an apical end opposite the coronal end, an outer surface, and a compartment extending therein from the coronal end toward the apical end, the implant body including a gap between the compartment and the outer surface, wherein the gap is a closed hermitically sealed space.

2. The dental implant of claim 1, wherein the compartment is defined by an internal surface being movable with respect to the outer surface of the implant body by deformation and flexibility of the implant body in a region closer to the coronal end than the apical end.

3. The dental implant of claim 2, wherein the gap extends circumferentially about a longitudinal axis of the implant body defined by an inner surface being closer to the longitudinal axis of the implant body and the outer surface of the implant body.

4. The dental implant of claim 3, wherein a radial distance between the inner surface of the gap to the outer surface of the gap tapers from a first distance proximate the coronal end to a second distance less than the first distance distal the coronal end.

5. The dental implant of claim 3, wherein the implant body includes a first portion including the compartment, and a second portion, the first portion and the second portion being connected by a transition zone in a coronal region of the implant body that deforms upon an application of force to the first portion allowing the first portion to move relative to the second portion, wherein the gap is located between the first portion and the second portion.

6. The dental implant of claim 5, wherein the first portion is welded to the second portion at the transition zone and wherein the gap is formed between the first portion and the second portion.

7. The dental implant of claim 5, wherein the first portion is formed from a first material including one of stainless steel, titanium and a polymer.

8. The dental implant of claim 5, wherein:
(i) a space defined by the gap includes a gap material different than a first material of the first portion and a second material of the second portion; and/or
(ii) a space defined by the gap is free of a nongaseous material.

9. The dental implant of claim 5, wherein the first portion is movable relative to the second portion in at least one of a radial direction generally perpendicular to the longitudinal axis of the implant body; a direction generally along the longitudinal axis of the implant body; and a rotational direction about the longitudinal axis of the implant body.

10. The dental implant of claim 2, wherein the implant body is made from one piece and formed in a 3D printing process.

11. The dental implant of claim 2, further including a prosthetic abutment having an apical portion received within the compartment and an opposing coronal portion;
and the dental implant further including a prosthetic crown secured to the coronal portion of the abutment, wherein the compartment moves about a bending region proximate an apical end of the gap in response to an application of a force to the prosthetic crown.

12. The dental implant of claim 5, wherein the first portion includes an extension member extending into an apical cavity of the second portion; and, wherein the second portion includes a bearing surface that allows the first portion and the extension member to move along the longitudinal axis of the implant body, while restricting movement of the extension member in a direction perpendicular to the longitudinal axis.

13. The dental implant of claim 11 wherein the gap is symmetrical about a longitudinal axis of the implant body and has a first geometry in an equilibrium position and a second geometry different than the first geometry in a non-equilibrium position upon an application of an external force to the prosthetic crown, the gap returning to the first geometry from the second geometry when the external force is removed from the prosthetic crown.

14. An implant comprising:
a fastener body having an externally threaded region with a distal tip and a proximal portion having a proximal end furthest from the distal tip along a longitudinal axis of the fastener body,
the fastener body including a hermetically sealed circumferentially extending gap between an outer surface of the fastener body and the longitudinal axis of the fastener body; the fastener body includes a deformation region closer to the proximal portion than the distal tip that deforms upon an application of a force to the proximal portion allowing the proximal portion to bend relative to the longitudinal axis of the threaded body.

15. The implant of claim 14, wherein the proximal portion bends relative to the longitudinal axis of the threaded region only along a single axis perpendicular to the longitudinal axis of the fastener body.

16. The implant of claim 15, wherein a radial distance between an inner surface of the gap and an outer surface of the gap varies between a first direction perpendicular to the longitudinal axis and a second direction perpendicular to the first direction and the longitudinal axis.

17. The implant of claim 16, wherein the externally threaded region is configured to be inserted into a bone of a patient in an in-use position and part of the proximal end remains exposed from the bone in an in-use position.

18. The implant of claim 17, wherein the proximal portion includes a tool receiving compartment to permit rotation of the fastener body to secure the threaded region into the bone of a patient, wherein the bone is a spinal bone.

19. The implant of claim 17, wherein the proximal portion of the fastener that has no bone fixation properties and extends outside the bone in the in-use position, the proximal portion includes a spherical or any other shape to be connected to an orthopedic system.

20. An orthopedic fastener comprising:
a fastener body having a head, a neck, a threaded body and a distal tip,
the fastener body including a hermetically sealed circumferentially extending gap between an outer surface of the fastener body and a longitudinal axis of the fastener body; the neck including a deformation region proximate the head that deforms upon an application of a force to the head allowing the head to bend relative to the longitudinal axis of the threaded body.
